(19) United States
(12) Patent Application Publication
(10) Pub. No.: US 2022/0234329 A1
(43) Pub. Date: Jul. 28, 2022

(54) METHOD AND APPARATUS FOR MAKING A NONWOVEN FABRIC

(71) Applicant: REIFENHÄUSER GMBH & CO. KG MASCHINENFABRIK, Troisdorf (DE)

(72) Inventors: Tobias WAGNER, Koeln (DE); Sebastian SOMMER, Troisdorf (DE); Patrick BOHL, Hennef (DE); Andreas ROESNER, Bonn (DE); Hans-George GEUS, Niederkassel (DE)

(21) Appl. No.: 17/614,466

(22) PCT Filed: Jul. 7, 2020
(86) PCT No.: PCT/EP2020/069133

§ 371 Date: Nov. 26, 2021

(30) Foreign Application Priority Data
Jul. 30, 2019 (EP) 19189231.4

(51) Int. Cl. B32B 5/26; D04H 3/02; D04H 3/16; D04H 3/147; B32B 5/02; B32B 5/08

(52) U.S. Cl. CPC B32B 5/267; D04H 3/02; B32B 5/08; D04H 3/147; B32B 5/022; D04H 3/16

(57) ABSTRACT

The invention relates to a device for producing a nonwoven fabric, wherein at least one spinning apparatus for spinning fibers is provided and a deposit conveyor is provided, on which the fibers can be deposited to form the nonwoven web. At least one hot-air pre-bonding apparatus is provided for the hot-air pre-bonding of the nonwoven web on the deposit conveyor. An additional conveyor for receiving the pre-bonded nonwoven web is arranged downstream of the deposit conveyor in the conveying direction of the nonwoven web, at least one final bonding apparatus being provided for the final bonding of the nonwoven web on the additional conveyor. The hot hot-air pre-bonding of the nonwoven web can be carried out on the deposit conveyor, with the stipulation that the nonwoven web has a strength in the machine direction (MD) of 0.6 to 4 N/5 cm before being transferred to the additional conveyor.

The invention relates to an apparatus for making a nonwoven fabric having at least one nonwoven web, having at least one spinneret or at least one spinning beam for spinning fibers, and a depositing conveyor, in particular a mesh belt on which the fibers can be deposited to form the nonwoven web. The invention further relates to a method of making a corresponding nonwoven fabric. In the context of the invention, fibers made of thermoplastic synthetic material are preferably continuous filaments made of thermoplastic material in the context of the invention. Continuous filaments differ because of their virtually endless length of staple fibers that have much smaller lengths of, for example, 10 mm to 60 mm. The endless filaments used in the context of the invention are, in particular, continuous filaments made by a spunbond process, preferably of thermoplastic material.

Apparatuses and methods of the above-mentioned type are known from practice in different embodiments. It is thus known to deposit endless filaments on a deposit mesh belt to form the nonwoven web, to subject it to preconsolidation and subsequently to carry out a final consolidation of the nonwoven web. The preconsolidation can be carried out, for example, with the aid of compacting rollers and the final consolidation in particular in a hot-air oven (by air bonding). Furthermore, it is also known that air or process air is sucked through the deposit mesh belt in the region where the filaments are deposited on the mesh belt. The preconsolidation and the final consolidation take place in many known apparatuses on the same deposit conveyor or mesh belt. The invention is based on the discovery that this performance of all consolidation measures on the same conveyor is not always advantageous.

So-called high-loft products are very preferred for certain applications. These are nonwoven fabrics or spunbonded webs having a relatively considerable thickness and softness. The manufacture of these high-loft products with the desired properties is not always simple, especially since the nonwoven materials must also be consolidated and the resultant strengthening impairs the thickness and/or the softness. Therefore, there is a conflict of objectives, on the one hand, of high softness and thickness and, on the other hand, sufficient strength or abrasion resistance of the nonwoven fabrics. In this regard, the previously known apparatuses and methods often have no satisfactory results.

In contrast, the object of invention is to provide an apparatus of the above-mentioned type that can achieve an advantageous preconsolidation and also an optimum final consolidation of nonwoven fabrics and with which, in addition, a nonwoven fabric of high thickness and high softness can also be made without problems if required. The invention further relates to a corresponding method of making such a nonwoven fabric.

In order to attain these objects, the invention proposes an apparatus for making a nonwoven fabric having at least one nonwoven web, wherein

at least one spinneret or at least one spinning beam is provided for spinning fibers,

a deposition conveyor, in particular a mesh belt, is provided on which the fibers can be deposited to form the nonwoven web,

at least one hot-air preconsolidator is provided for hot-air preconsolidation of the nonwoven web on the deposit conveyor or on the deposit mesh belt,

a downstream conveyor, in particular in the form of a conveyor belt,

at least one downstream conveyor is provided downstream of the deposit mesh belt in the travel direction of the nonwoven web, in particular in the form of a conveyor belt, for receiving the preconsolidated nonwoven web from the deposit conveyor,

wherein at least one final consolidator, in particular at least one hot-air final consolidator, is provided for final consolidation or hot-air final consolidation of the nonwoven web on the downstream conveyor or on the conveyor belt, and

wherein the hot-air preconsolidation of the nonwoven web on the depositing conveyor or on the mesh belt can be carried out such that the nonwoven web has a strength in the machine direction (MD) of 0.5 to 5 N/5 cm, in particular of 0.7 to 3.5 N/5 cm and preferably of 0.8 to 3.5 N/5 cm before transfer to the downstream conveyor or to the conveyor belt. Machine direction (MD) means, within the scope of the invention, in particular the travel direction of the depositing conveyor or the travel direction of the nonwoven web.

The nonwoven fabric made according to the invention can only have a nonwoven web or a nonwoven layer, or it can also have a plurality of nonwoven webs or nonwoven layers one atop the other, combined to form a nonwoven laminate. If a plurality of nonwoven webs are one above the other, a spinneret or spinning beam is expediently provided to make each nonwoven web. As a rule, the number of spinnerets or spinning beams one downstream of the other corresponds to the number of nonwoven webs or nonwoven layers that are combined one above the other to form the nonwoven laminate.

The deposit conveyor or the mesh belt is designed in particular as an endlessly circulating storage mesh belt. The conveyor or conveyor belt is expediently designed as an endlessly circulating conveyor belt. It is within the scope of the invention that the deposit conveyor or the storage mesh belt is designed to be air-permeable for through passage of process air. In principle, it is also within the scope of the invention that the downstream conveyor or conveyor belt can be designed to be air-permeable. In principle, the downstream conveyor can moreover also be designed as a roller or drum or the like.

According to the invention, separate conveyors are used for the preconsolidation of the nonwoven web on the one hand and for the final consolidation of the nonwoven web, namely the deposit conveyor or the deposit mesh belt for the hot-air preconsolidation and the downstream conveyor or conveyor belt for the final consolidation or the final hot-air consolidation. To this extent, the invention is based on the discovery that this separation of the conveyors for preconsolidation on the one hand and for the final consolidation on the other hand for the nonwoven fabric to be made is surprisingly particularly advantageous and in particular also leads to advantages with respect to process control for making the nonwoven fabric. This is especially true for nonwoven materials with low surface densities and/or for the manufacture of nonwoven fabrics at higher manufacture speeds.

The invention is based, inter alia, on the discovery that the apparatus according to the invention and a method carried out with the apparatus according to the invention are particularly advantageous in terms of energy. In the systems known from the prior art, in which the preconsolidation and the final consolidation are carried out on the same deposit mesh belt relatively high energy losses inevitably occur. In the hot-air final consolidator, the nonwoven fabric or the mesh belt is heated to relatively high temperatures. The endlessly circulating deposit mesh belt is then again guided through the storage area for the fibers, in which process air is sucked through the deposit mesh belt and the latter is consequently cooled relatively clearly. This cooled mesh belt then has to be heated again in an energy-consuming manner in the final consolidator. There are thus considerable energy losses, which increase even further at higher manufacture speeds, for example in multibeam systems. These are advantageously avoided within the scope of the this invention.

The apparatus according to the invention is also particularly suitable for the manufacture of high-loft products. With the apparatus, it is possible to achieve an optimum compromise between sufficient thickness and high softness of the nonwoven fabric and also a satisfactory strength of the nonwoven fabric. The invention is based on the discovery that the nonwoven fabric should have a strength in the machine direction (MD) in the range claimed according to the invention after the preconsolidation. As a result, voluminous and soft nonwoven fabrics with optimum strength can be achieved.

The gauge according to the invention or the apparatus according to the invention has proven particularly useful in nonwoven laminates consisting of at least two nonwoven webs or more than two nonwoven webs where these nonwoven laminates are made using a two-beam system or with a multi-beam installation.

According to a particularly preferred embodiment of the invention, the nonwoven fabric is a nonwoven laminate of at least two nonwoven webs, wherein

at least two spinnerets or spinning beams are provided for making the fibers for these nonwoven webs,

a first spinneret or a first spinning beam is provided for spinning first fibers,

the first fibers can be deposited on the deposit conveyor or on the mesh belt to form a first nonwoven web,

a second spinneret or a second spinning beam is provided for spinning second fibers, and the second spinning beam is provided downstream of the first spinning beam in the travel direction of the depositing conveyor so the second fibers can be deposited on the depositing conveyor or on the first nonwoven web to form the second nonwoven web,

at least one hot-air preconsolidator is provided between the first and the second spinning beam for preconsolidation of the first nonwoven web,

in the travel direction of the fiber tray downstream of the second spinning beam, at least one second hot-air preconsolidator is provided for the hot-air preconsolidation of the second nonwoven web or laminate of the first and second nonwoven web,

the laminate is or is transferred from the deposit conveyor to the downstream conveyor, in particular in the form of the conveyor belt, and the laminate is finally reinforced with the final consolidator, in particular with the hot-air final consolidator, on the downstream conveyor, and

the final hot-air preconsolidation of the first nonwoven web or laminate on the deposit conveyor can be carried out such that the laminate has a strength in the machine direction (MD) of 0.5 to 5 N/5 cm, in particular of 0.7 to 3.5 N/5 cm and preferably of 0.8 to 3.5 N/5 cm before transfer to the downstream conveyor.

If two or more spinnerets or spinning beams are used in the context of the invention and two or more nonwoven webs are made for a nonwoven laminate according to the invention, it is within the scope of the invention that at least one hot-air preconsolidator for hot-air preconsolidation of the nonwoven web or nonwoven web structure is provided downstream of each spinneret or spinning beam. Furthermore, it is within the scope of the invention that the depositing of the fibers for the individual nonwoven webs and the hot-air preconsolidation are carried out on one and the same deposit conveyor or storage mesh belt. The final consolidation takes place subsequent thereto on the downstream conveyor or on the conveyor belt. In principle, it is also within the scope of the invention that at least one intermediate conveyor or at least one intermediate conveyor belt is interposed between the deposit conveyor and the downstream conveyor when making only one nonwoven web or during the manufacture of a plurality of nonwoven webs having a plurality of spinning beams. In this case, the teaching according to the invention is preferably to be understood as meaning that the individual nonwoven web or the nonwoven web unit has the strength in the machine direction (MD) in the claimed range before transfer to the at least one intermediate conveyor. The intermediate conveyor can moreover also be a roller or deflection roller, a roller, a drum or the like.

It is within the scope of the invention that at least one spinneret or at least one spinning beam of the apparatus according to the invention or the apparatus component of the apparatus according to the invention assigned to at least one spinneret or at least one spinning beam is designed as a spunbond apparatus for making a spunbond nonwoven web made of continuous filaments. According to one embodiment of the invention, all spinnerets or The spinning beam and thus the corresponding apparatus components are each designed as a spunbond apparatus for making spunbond nonwoven webs with continuous filaments.

A very particularly preferred embodiment of the invention is characterized in that at least one of the spinnerets or at least one of the spinning beams is designed to produce bicomponent fibers or multicomponent fibers and in particular for making bicomponent filaments or multicomponent filaments. According to a recommended embodiment of the invention, all spinnerets or all the spinning beams of the apparatus according to the invention are designed to produce bicomponent fibers/multicomponent fibers, in particular bicomponent filaments/multicomponent filaments. It is furthermore within the scope of the invention that the apparatus for making at least one nonwoven fabric or at least one nonwoven web is formed from crimped fibers or crimped continuous filaments. Preferably, at least one spinneret or at least one spinning beam for making crimped fibers or for making crimped continuous filaments. When a plurality of spinning beams are used for the apparatus according to the invention, at least one spinning beam or at least two spinning beams or all spinning beams are configured for the manufacture of crimped fibers or crimped continuous filaments.

The embodiment of the apparatus according to the invention or the method according to the invention for making at least one nonwoven web from crimped fibers or continuous filaments is of particular importance. In this way, a high-loft nonwoven fabric can be made very easily. The invention is based on the discovery that the advantageous properties of such a high-loft product are surprisingly based on the construction of the apparatus according to the invention or as a result of carrying out the method according to the invention, and nevertheless an effective process control with sufficient strength of the nonwoven web or nonwoven webs is possible. In order to produce crimped fibers or continuous filaments, fibers or continuous filaments with an eccentric core/sheath configuration or with a side-by-side configuration can be used in the context of the invention. In this case, fibers or endless filaments with eccentric core-sheath configuration are preferred. These last-mentioned fibers have proven particularly suitable for the apparatus according to the invention or for the method according to the invention. A very preferred embodiment of endless filaments used in the context of the invention with an eccentric core-sheath configuration is explained in more detail below.

A very expedient embodiment of the invention is characterized in that at least one cooler for cooling the fibers and at least one stretcher for elongating the fibers, which is provided to the cooler, is provided for the fibers or filaments spun with at least one spinning beam. Advantageously, at least one diffuser follows the stretcher in the flow direction of the fibers/filaments. A very recommended embodiment of the invention is characterized in that the cooler/stretcher subassembly is designed as a closed unit and that no further air is supplied from the outside into this subassembly except for the cooling air in the cooler. The fibers/filaments leaving the diffuser are expediently deposited directly on the deposit conveyor or on the deposit mesh belt.

A particularly proven embodiment of the invention is characterized in that the hot-air preconsolidator is at least one hot-air knife and/or at least one hot-air oven. If two or more spinning beams are used in the context of the apparatus according to the invention, the first hot-air preconsolidator is preferably between the first spinning beam and the second spinning beam in the form of at least one first hot-air knife and/or in the form of at least one first hot-air oven. Expediently, the second hot-air preconsolidator is downstream of the second spinning beam in the form of at least one second hot-air knife and/or in the form of at least one second hot-air oven.

A proven embodiment of the invention is characterized in that at least one hot-air knife is provided downstream of an apparatus component having a spinning beam, and in that at least one hot-air oven is provided downstream of this hot-air knife. An embodiment of the invention is characterized in that only one hot-air knife is provided downstream of the spinning beam and that in turn only one hot-air oven is provided downstream of this hot-air knife.

When a plurality of spinnerets or spinning beams are used in the context of the apparatus according to the invention, at least one first hot-air knife is first provided downstream of the first spinning beam in the travel direction of the first nonwoven web, and at least one first hot-air oven is provided downstream of this first hot-air knife upstream of the second spinning beam. Furthermore, at least one second hot-air knife is first provided downstream of the second spinning beam in the travel direction of the laminate, and at least one second hot-air oven is again provided downstream of this second hot-air knife. It is within the scope of the invention that the nonwoven web or the nonwoven web laminate has left a hot-air oven as the last hot-air preconsolidator before transfer to the downstream conveyor or to the conveyor belt.

In principle, other combinations of hot-air preconsolidators are also possible within the scope of the invention. Thus, only one hot-air knife can be provided downstream of a spinning beam or in a two-beam installation or multi-beam installation of at least one spinning beam as a hot-air preconsolidator. According to one embodiment, a hot-air knife is provided downstream of a first spinning beam and a hot-air oven for preconsolidation is again provided downstream of this hot-air knife. Here, only one hot-air knife is provided downstream of the second beam as a hot-air preconsolidator. Another embodiment is characterized in that only one hot-air knife is provided downstream of the first spinning beam as a hot-air preconsolidator and a hot-air knife is provided downstream of the second spinning beam and a hot-air oven is again provided downstream of this hot-air knife as a hot-air preconsolidator. According to another embodiment variant, only one hot-air oven could also be provided downstream of each spinning beam as a hot-air preconsolidator. In this respect, in the context of the invention, there are various variants for combinations of hot-air preconsolidators.

A recommended embodiment of the invention is characterized in that a hot-air knife acts on the nonwoven web or laminate with hot air over a width region in the machine direction (MD) of 15 mm to 300 mm, in particular of 30 mm to 250 mm, preferably of 40 mm to 200 mm and preferably of 40 mm to 150 mm. Expediently, the spacing between the at least one hot-air nozzle of the hot-air knife and the surface of the deposit conveyor or of the storage mesh belt 2 mm to 200 mm, in particular 3 mm to 100 mm. The above-mentioned width ranges and spacing ranges in a multi-beam installation for each hot-air knife used for the hot-air preconsolidator apply expediently.

Furthermore, a proven embodiment of the invention is characterized in that a hot-air oven applies hot air to the nonwoven web or laminate over a width region in the machine direction (MD) of 280 mm to 2000 mm, in particular of 290 mm to 1800 mm and preferably of 300 mm to 1500 mm. It is recommended that the hot-air outlet openings of the hot-air oven face the surface of the delivery conveyor or the storage mesh belt has a spacing of 12 mm to 200 mm, in particular of 20 mm to 150 mm and preferably of 25 mm to 120 mm. The above-mentioned width ranges and/or spacing ranges expediently apply to a multi-beam installation for each hot-air oven used for hot-air preconsolidation.

It is within the scope of the invention that a cooling field, in which the nonwoven web is stabilized by cooling, is provided after a hot-air knife or after each hot-air knife and/or after a hot-air oven or after each hot-air oven. Such a cooling field is expediently for example 400 mm to 600 mm long and is traversed, for example, by cooling air at a speed of 1 to 2 m/s. As a result, both the nonwoven web and the deposit conveyor are cooled.

A particularly preferred embodiment, which is of special importance in the context of the invention, is characterized in that the temperature of the surface of the downstream conveyor or conveyor belt in the travel direction upstream of the hot-air final consolidator is higher than the temperature of the surface of the depositing conveyor or of the mesh belt in the transfer region of the nonwoven web or laminate to the downstream conveyor or to the conveyor belt.

If, according to an embodiment of the invention, at least one intermediate conveyor is provided between the deposit conveyor and the downstream conveyor, this embodiment means in particular that the temperature of the surface of the downstream conveyor, in particular of the conveyor belt in the travel direction upstream of the hot-air final consolidator, is higher than the temperature of the surface of the depositing conveyor or storage mesh belt in the transfer region of the nonwoven web or of the laminate to the intermediate conveyor and/or higher than the temperature of the surface of the intermediate conveyor. In these embodiments, the surface temperature of the downstream conveyor or conveyor belt is expediently at least 5° C., preferably at least 10° C. and preferably at least 15° C. and very preferably at least 20° C. higher than this surface temperature of the deposit conveyor and/or of the intermediate conveyor. If, within the scope of the invention, an intermediate conveyor is used that merely has a transport function, the surface temperature of this intermediate conveyor is expediently lower than the upper surface temperature of the downstream conveyor and the surface temperature of the intermediate conveyor is preferably also lower than the temperature of the nonwoven web or laminate when entering the intermediate conveyor.

In order attain the object of the invention, the invention further relates to a method for making a nonwoven fabric having at least one nonwoven web, and fibers are spun and deposited on a deposit conveyor, in particular on a deposit mesh belt, to form the nonwoven web, wherein

the nonwoven web is preconsolidated with hot air on the deposit conveyor and the nonwoven web is transferred from the deposit conveyor or the deposit mesh belt to a downstream conveyor or to a conveyor belt,

the hot-air preconsolidation is carried out such that the nonwoven web has a strength in the machine direction (MD) of 0.5 to 5 N/5 cm, in particular of 0.7 to 3.5 N/5 cm and preferably of 0.8 to 3.5 N/5 cm before transfer to the downstream conveyor.

A particularly preferred embodiment of the method according to the invention is characterized in that

a nonwoven laminate is made from at least two nonwoven webs, and in particular at least one of the nonwoven webs has crimped fibers, and first fibers are spun and deposited on a deposit conveyor, in particular on a deposit mesh belt, to form a first nonwoven web,

second fibers are spun and wherein these second fibers are deposited on the first nonwoven web transported on the deposit conveyor to the second nonwoven web or to the laminate from the two nonwoven webs,

after depositing the first fibers and before depositing the second fibers, the first nonwoven web is preconsolidated with hot air, and, after depositing the second fibers, the second nonwoven web or laminate is preconsolidated with hot air from the first nonwoven web and the second nonwoven web, and

the laminate is transferred from the deposit conveyor or the deposit mesh belt to the downstream conveyor or is transferred to the conveyor belt and wherein the hot-air preconsolidation is carried out such that the laminate has a strength in the machine direction (MD) of 0.5 to 5 N/5 cm, in particular of 0.7 to 3.5 N/5 cm and preferably of 0.8 to 3.5 N/5 cm before transfer to the downstream conveyor.

A particularly proven embodiment of the method according to the invention is characterized in that the fibers, in particular the fibers of the first spinning beam and/or the fibers of the second spinning beam, are spun as spunbond filaments or continuous filaments, in particular as bicomponent filaments or filaments, and multicomponent filaments are spun and preferably deposited as crimped filaments-in particular to the first nonwoven web and/or to the second nonwoven web-deposited. According to a particularly preferred embodiment of the invention, the fibers, in particular the fibers of the first spinning beam and/or the fibers of the second spinning beam, are spun as bicomponent filaments or multicomponent filaments having an eccentric core-sheath configuration.

In the context of the invention, bicomponent filaments or multicomponent filaments having an eccentric core-sheath configuration are particularly useful, in which the sheath has a constant thickness d or a substantially constant thickness d over at least 20%, in particular over at least 25%, preferably over at least 30%, preferably over at least 35% and very preferably over at least 40% and particularly preferably over at least 45% of the filament circumference. It is very preferred within the scope of the invention that the sheath of the filaments has the constant thickness d or the substantially constant thickness d over at least 50%, preferably over at least 55% and preferably over at least 60% of the filament circumference. In these filaments, the core expediently amounts to more than 50%, in particular more than 55%, preferably more than 60%, preferably more than 65%, of the area of the filament cross-section of the filaments. It is recommended that the core of these filaments in the filament cross-section be circular segment-shaped and has, with respect to its circumference, a circularly arcuate or substantially circularly arcuate circumferential section and a linear or substantially linear circumferential section. Furthermore, in these filaments, it is preferred that the sheath of the filaments, as seen in the filament cross-section, is formed with a circularly segmental cross-section outside the casing region with the constant thickness d, and this circular segment has, with respect to its circumference, a circularly arcuate or substantially circularly arcuate circumferential portion and a planar or substantially linear circumferential portion. According to a very recommended embodiment, the thickness of the sheath of these preferred filaments in the region of the constant or substantially constant thickness d of the sheath is less than 10%, in particular less than 8% and preferably less than 7% of the filament diameter D or the largest filament diameter D. It is also within the scope of the invention that in these preferred filaments with respect to the filament cross-section, the spacing of the centroid of the core from the centroid of the sheath is 5% to 45%, in particular 6% to 40% and preferably 6% to 36% of the filament diameter D or the largest filament diameter D.

A particularly recommended embodiment of the invention is characterized in that the fibers or filaments made according to the invention consist or consist essentially of at least one polyolefin. When bicomponent filaments or multicomponent filaments are made within the scope of the invention, these are preferably bicomponent filaments or multicomponent filaments, in which at least one component or both or both all components consist of at least one polyolefin or substantially of at least one polyolefin. In the manufacture of filaments having an eccentric core/sheath configuration, at least the sheath preferably consists of at least one polyolefin or substantially of at least one polyolefin. According to a very proven embodiment, the sheath consists of polyethylene or substantially of polyethylene and preferably the core consists of polypropylene or polypropylene substantially made of polypropylene. According to another recommended embodiment, the core consists of at least one polyester or substantially of at least one polyester and the sheath consists of at least one polyolefin or substantially of at least one polyolefin. Polyethylene terephthalate (PET) is preferably used as the polyester in the context of the invention. In a preferred embodiment, the core consists of PET or PET Essentially made of PET and the sheath consists of polyethylene or substantially of polyethylene. A further embodiment is characterized in that the core consists or consists essentially of at least one polyester and that the sheath consists or consists essentially of at least one copolyester. It is within the scope of the invention that the plastic component of the sheath has a lower melting point than the plastic component of the core. Within the scope of the invention, fibers or filaments from the above-mentioned plastics have proven to be very particularly suitable. In particular, bicomponent filaments or multicomponent filaments having an eccentric core-sheath configuration have proven successful, the casing of which consists of polyethylene or essentially of polyethylene and the core of which consists of polypropylene or essentially of polypropylene.

A very proven embodiment of the invention is characterized in that the components of the filaments or the core and/or the sheath of the filaments with an eccentric core/sheath configuration consist of at least one polymer from the group “polyolefin, polyolefin copolymer, in particular polyethylene, polypropylene, polyethylene copolymer, polypropylene copolymer; polyester, polyester copolymer, in particular polyethylene terephthalate (PET), PET copolymer, polybutylene terephthalate (PBT), PBT copolymer, polylactide (PLA), PLA copolymer.” It is also within the scope of the invention that mixtures or blends of the aforementioned polymers can be used for a component or the core and/or the sheath. Furthermore, it is within the scope of the invention that, in the case of continuous filaments having an eccentric core-sheath configuration, the plastic in the sheath has a lower melting temperature than the plastic in the core.

In the case of the manufacture of a nonwoven fabric or a single-layer nonwoven product, the hot-air preconsolidation of the nonwoven web takes place at a temperature of 80° C. to 200° C. in particular from 100° C. to 175° C. preferably from 110° C. to 150° C. and very preferably from 115° C. to 140° C. It is further advisable for the hot air to have a speed of 1.9 to 6 m/s, in particular of 2 to 5 m/s and preferably of 2.2 to 4.5 m/s in the hot-air preconsolidation with a hot-air knife.

A particularly recommended embodiment of the method according to the invention is characterized in that at least one nonwoven web, in particular the first nonwoven web and/or the laminate of the first nonwoven web and the second nonwoven web are respectively first preconsolidated by a hot-air knife and exclusively by a hot-air oven with hot air. The hot-air preconsolidation takes place by the hot-air knife at a hot-air temperature of 80° C. to 200° C., in particular of 100° C. to 180° C. and preferably of 120° C. to 170° C. and very preferably of 120° C. to 160° C. It is further advisable for the hot air to have a speed of 1.9 to 6 m/s, in particular of 2 to 5.5 m/s and preferably of 2.2 to 4.5 m/s during the hot-air preconsolidation with a hot-air knife.

If the hot-air preconsolidation of a nonwoven web or a nonwoven fabric is carried out according to an embodiment with only one preconsolidator, in particular with only one hot-air knife, the hot-air temperature is carried out in a range from 80° C. to 250° C., in particular from 110° C. to 200° C. and preferably from 120° C. to 190° C. and very preferably from 130° C. to 180° C. It is also recommended that the hot air has a speed of 1.9 to 8 m/s, in particular of 2 to 5.5 m/s and preferably of 2.2 to 5.5 m/s during the hot-air preconsolidation with a hot-air knife. It is within the scope of the invention that the nonwoven web, in particular the first nonwoven web and/or the laminate of a first nonwoven web and a second nonwoven web, is preconsolidated by at least one hot-air oven with hot air, and this hot-air preconsolidation is carried out with hot air at a temperature of 110° C. to 180° C., in particular of 115° C. to 170° C. and preferably of 120° C. to 160° C. The hot air has a speed of 1 to 2.5 m/s, in particular of 1.1 to 1.9 m/s and preferably of 1.2 to 1.8 m/s during this hot-air consolidation with a hot-air oven.

It is also within the scope of the invention that after transfer of the nonwoven web or the nonwoven laminate from the deposit conveyor to the downstream conveyor or to the conveyor belt, final consolidation of the nonwoven web or laminate takes place. It has proven successful that the final consolidation is carried out as hot-air final consolidation. The hot-air final consolidation is expediently carried out in a hot-air oven and/or in a drum oven and/or in a double belt oven and/or in a series thermobonder. A recommended embodiment is characterized in that the final consolidation takes place in a hot-air oven by through air bonding. It is also within the scope of the invention that the final consolidation can be a combination of hot-air final consolidation and heating of the nonwoven fabric or nonwoven laminate with electromagnetic waves (for example IR or microwave radio-frequency heating). The temperature of the hot air is expediently more than 100° C., preferably more than 110° C. The speed of the hot air during this final consolidation is proven to be more than 1 m/s, preferably more than 1 m/s. It is recommended that the hot-air final consolidation be carried out such that the resulting nonwoven web or the resulting laminate has a strength in the machine direction (MD) of at least 20 N/5 cm, preferably of at least 23 N/5 cm. Particularly preferably, the nonwoven web or after the hot-air final consolidation, the laminate has a strength in the machine direction (MD) of more than 25 N/5 cm. In the manufacture of a nonwoven laminate from two nonwoven webs by a two-beam installation, the resulting nonwoven laminate has, in particular, a thickness of 0.40 mm to 0.80 mm and preferably of 0.45 mm to 0.70 mm. These thickness data relate in particular to nonwoven laminates having a weight per unit area of 12 to 50 g/m².

Preferably, a manufacture speed of at least 100 m/min, in particular of at least 200 m/min, is used within the scope of the method according to the invention. According to the invention, nonwoven fabrics or laminates having a surface weight of 12 to 50 g/m², preferably of 20 to 40 g/m², are expediently made.

It is within the scope of the invention that the titer of the filaments used for the nonwoven web or for the nonwoven laminate is between 1 and 12. According to a very recommended embodiment, the titer of the filaments is between 1.0 and 2.5, in particular between 1.5 and 2.2, and preferably between 1.8 and 2.2. Above all, filaments with the titer of 1.5 to 2.2 and preferably 1.8 to 2.2 have proved to be very particularly useful in the context of the invention.

According to a recommended embodiment of the invention, the hot-air preconsolidation is carried out in the travel direction downstream of a spinning beam with at least two hot-air preconsolidators, preferably with at least one hot-air knife and with at least one hot-air oven. A very proven embodiment of the invention is characterized in that a region of the depositing conveyor is provided between two hot-air preconsolidators, in particular between a hot-air knife and a hot-air oven, in which region no or only a very small extraction of process air takes place. In the context of the invention, this region is referred to as a suction gap or suction gap region. The extraction speed here is either zero or approximately zero or it is at least significantly lower than the extraction speed V₂ in the second suction region and as the suction speed V₃ in the region of the second hot-air preconsolidator or in the region of the hot-air oven. It is essential that the suction gap region is provided on the deposit conveyor or on the deposit mesh belt. If the suction speed V_{L} in the suction gap region is greater than zero, it is preferably 1% to 15%, in particular 1.2% to 10% and preferably 1.4% to 8% and very preferably 1.7% to 3% of the extraction speed V_{H} in the upstream main suction region. This means in particular the local minimum of the suction speed in the suction gap region. Such a suction gap has proven particularly useful in the context of the invention. It has been found that nonwoven webs or nonwoven laminates with optimum thickness can thus be made, which nevertheless can be given sufficient strength. The suction gap has the advantage that a further preconsolidator can additionally be introduced here, in particular in the form of a roller pair or compacting roller pair. A particularly preferred embodiment of the invention is therefore characterized in that a pair of rollers or a grain packaging roller pair can be pivoted into the suction gap region and can also be pivoted or removed again if required. The length of the suction gap region in the machine direction (MD) or in the travel direction of the nonwoven web/laminate is preferably 0.3 m to 5 m, preferably 1.0 m to 4.5 m and in particular 1.2 m to 4 m.

The invention is based on the discovery that with the apparatus according to the invention and with the method according to the invention, a nonwoven fabric or a nonwoven laminate with the desired properties can be made very specifically and functionally as well as with relatively little effort and, in particular, with little energy. In this case, high-loft products can be made in a simple and problem-free manner. Nonwoven fabrics with relatively high thickness and high softness and nevertheless adequate strength. Above all, the nonwoven fabrics made according to the invention have sufficient strength in order to transfer them from the deposit conveyor to the downstream conveyor for the final consolidation. In addition, the nonwoven fabrics made according to the invention are distinguished by excellent abrasion resistance or abrasion resistance. Furthermore, nonwoven materials with a very homogeneous surface can be made, which are virtually defect-free and in particular do not have filament agglomerates due to blow-back effects. The method according to the invention can be carried out in a relatively simple manner and above all in a little energy-consuming manner.

The invention is explained in more detail below on the basis of a drawing illustrating only one embodiment. In a schematic representation:

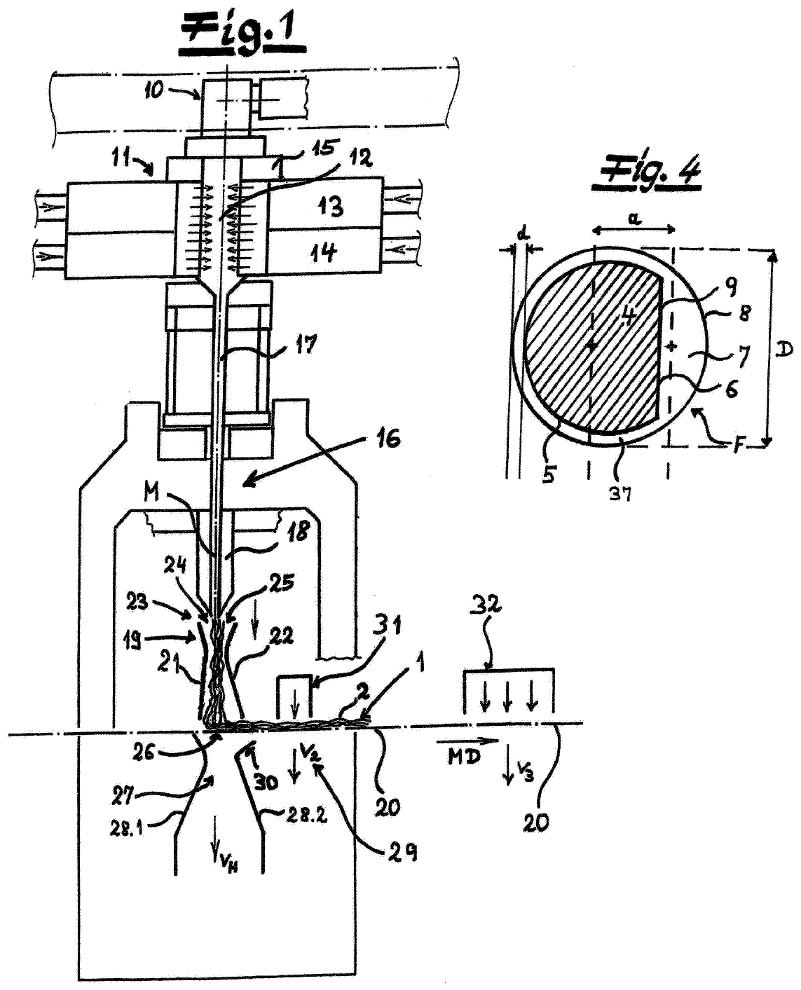

FIG. 1 is a vertical section through an apparatus according to the invention for making a spunbond nonwoven fabric,

FIG. 2 shows the object according to FIG. 1 in the region of the deposit conveyor with a downstream conveyor or conveyor belt provided thereto,

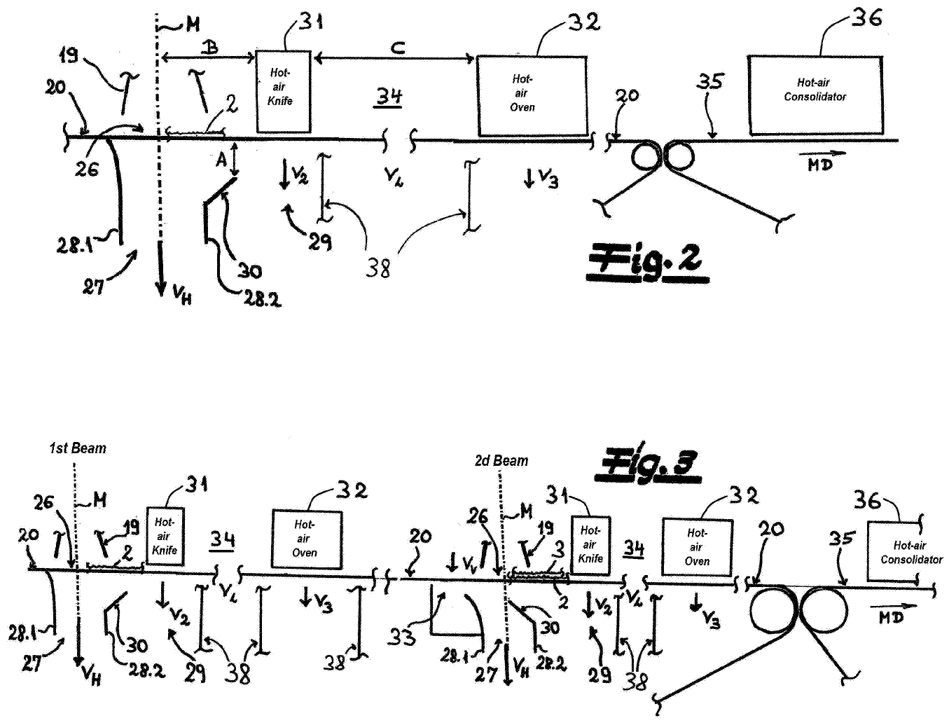

FIG. 3 is a vertical section through a two-beam system according to the invention, and

FIG. 4 is a section through a continuous filament that is preferably used in the context of the invention and has an eccentric core-sheath configuration.

FIG. 1 shows an apparatus according to the invention for making a nonwoven fabric 1 with at least one nonwoven web 2, 3 made of fibers made of thermoplastic material. The fibers are preferably continuous filaments F made of thermoplastic material here. The apparatus shown in FIG. 1 is a spunbond apparatus for making a nonwoven fabric 1 from endless filaments F.

The apparatus comprises a spinneret 10 for spinning the endless filaments F, and these spun continuous filaments F are introduced into a cooler 11 with a cooling chamber 12. Preferably and here, air supply manifolds 13, 14 one above the other are provided on two opposite sides of the cooling chamber 12. Air of different temperatures is expediently introduced into the cooling chamber 12 from these air supply manifolds 13, 14 provided one above the other. A monomer extractor 15 is between the spinneret 10 and the cooler 11 here. Unwanted gases generated during the spinning process can be removed from the apparatus by this monomer extractor 15. These gases can be, for example, monomers, oligomers or decomposition products and the like.

The cooler 11 is preferably and here followed by a stretcher 16 for stretching the endless filaments F is provided downstream in the filament flow direction. Preferably and here, the stretcher 16 has an intermediate passage 17 that connects the cooler 11 to a stretching shaft 18 of the stretcher 16. According to a particularly preferred embodiment and here, a subassembly formed from the cooler 11 and the stretcher 16 or a subassembly formed by the cooler 11, the intermediate passage 17 and the expansion shaft 18 is closed and, apart from the supply of cooling air in the cooler 11, no further air movement is allowed from outside into this subassembly.

A diffuser 19 through which the continuous filaments F are guided preferably follows the stretcher 16, here in the filament flow direction. After passing through the diffuser 19, the endless filaments F are preferably deposited on a conveyor designed constituted by a mesh belt 20 here. The deposit mesh belt 20 is preferably here designed as an endlessly circulating storage mesh belt 20. The deposit mesh belt 20 is expediently designed to be air-permeable, process air can be sucked from below through the deposit mesh belt 20.

According to a proven embodiment and here, the diffuser 19 or the diffuser 19 directly above the deposit mesh belt 20 has two opposite lower diverging diffuser walls 21, 22. These diverging diffuser walls 21, 22 are preferably designed asymmetrically with respect to the central plane M of the apparatus or diffuser 19. Expediently and here, the upstream diffuser wall 21 forms a smaller angle β with the central plane M than the downstream diffuser wall 22. The angle β, which the upstream diffuser wall 21 forms with the central plane M, is recommended to be at least 1° smaller than the angle β that the downstream diffuser wall 22 forms with the central plane M. It is within the scope of the invention that the lower ends of the diverging diffuser walls 21, 22 have different spacings e₁ and e₂ to the central plane M of the apparatus or diffuser 19.

The spacing e₁ of the lower end of the upstream diffuser wall 21 to the central plane M is less than the spacing e₂ of the lower end of the downstream diffuser wall 22 to the central plane M The terms upstream and downstream relate in particular to the travel direction of the mesh belt 20 or to the travel direction of the nonwoven web 2, 3. According to a preferred embodiment of the invention, the ratio of the spacings e₁:e₂ is 0.6 to 0.95, preferably 0.65 to 0.9 and in particular 0.7 to 0.9.

It is within the scope of the invention that two opposite secondary air inlet gaps 24 and 25 are provided at the upstream end 23 of the diffuser 19 and are each on one of the two opposite diffuser walls. Preferably, a lower secondary air volume flow can be introduced through the secondary air inlet gap 24 on the inlet side in relation to the travel direction of the deposit mesh belt 20 than through the downstream secondary air inlet gap 25. In this case, it is recommended that the secondary air volume flow of the upstream secondary air inlet gap 24 is at least 5%, preferably by at least 10% and in particular by at least 15% smaller than the secondary air volume flow through the downstream secondary air inlet gap 25. This embodiment with the different secondary air volume flows at the secondary air inlet gaps is of particular importance in view of the solution to the technical problem. The same also applies to the asymmetrical design of the diffuser 19. Furthermore, it is within the scope of the invention that at least one suction device is present that sucks air or process air through the deposit mesh belt 20 in a main suction region 27 in the storage region or in the main storage region 26 of the filaments F. The main suction region 27 is expediently and here below the deposit conveyor or below the deposit mesh belt 20 in an inlet region of the deposit mesh belt 20 and in an outlet region of the deposit mesh belt 20 by a respective suction separating wall 28.1 or 28.2.

According to a recommended embodiment of the invention, at least one, the suction wall 28.1 or 28.2 has, at its upper end, a partition wall designed as a spoiler 30. Preferably and here, the spoiler 30 is provided on the downstream suction wall 28.2. Here, the spoiler 30 is an integral part of the downstream suction wall 28.2 and merely as an angled section of this suction wall 28.2. In this recommended embodiment, the spoiler 30 is expediently designed as an obliquely angled spoiler 30 with a straight or substantially planar shape. Preferred and here according to FIGS. 1 and 2 and in the case of the first left-hand region of FIG. 3 the spoiler 30 is angled to the side of the associated suction wall 28.2 facing away from the center of the main suction region 27. On the other hand, the spoiler 30 is expediently angled here on the right-hand portion in FIG. 3 to the side of the associated suction wall 28.2 that faces the center of the main suction region 27. This different orientation of the spoilers 30 in a two-beam system or in the context of the invention, multi-beam installation is also of particular importance. The preferably provided spoiler 30 ensures that in the embodiment according to FIGS. 1, 2 and 3 (first beam, left-hand side), a continuous or linear continuous transition of the higher suction-suction speed V_{H} in the main suction region 27 to the significantly lower suction speed V₂ takes place in the second suction region 29 immediately downstream of the main suction region 27. Here FIG. 3 (right-hand side, second beam), the spoiler 30, which is angled toward the center of the main suction region 27, ensures that the suction speed V_{V} in a suction region 33 upstream of the main suction region 27 increases continuously and linearly to the higher extraction speed V_{H} in the main suction region 27 and in particular does not take place abruptly.

In the context of the invention, the angled spoiler 30 is of particular importance in that its upper end maintains a relatively large spacing A from the deposit conveyor or the deposit mesh belt 20. This spacing A is preferably 10 mm to 250 mm, preferably 25 mm to 200 mm, expediently 28 mm to 150 mm and in particular 30 mm to 120 mm According to a very preferred embodiment, the spacing A is 20 mm to 160 mm, proven 20 mm to 150 mm and, according to one embodiment, 25 mm to 150 mm. Therefore, the spacing of the upper end of the relevant suction wall 28.2 is significantly greater than corresponding spacings in installations known from the prior art. The invention is based on the discovery that a particularly soft and continuous transition of the extraction speeds takes place by maintaining this spacing A. This is advantageous because as a result disadvantageous effects that impair the homogeneity of the nonwoven web 2, 3 on the nonwoven web surface or nonwoven web surface are avoided. Above all, so-called blow-back effects are avoided or reduced as a result. This is a negative influence on the filaments of the nonwoven web 2, 3, which results in an abrupt extraction speed change. Thus, in many installations known from the prior art, in the event of an abrupt transition from the high extraction speed V_{H} in the main suction region 27 to a lower extraction speed in the following region of the mesh belt 20, filaments F are withdrawn or pulled out from the lower evacuated region in the higher-level area. This blow-back effect results in interfering filament agglomerates and thus inhomogeneities in the nonwoven web 2, 3. The preferably provided spoiler 30 thus ensures largely defect-free nonwoven webs 2, 3.

According to the invention, at least one hot-air preconsolidator is provided for hot-air preconsolidation of the nonwoven web 2, 3 on the deposit conveyor or on the deposit mesh belt 20. In the embodiment according to FIG. 2, only one spinneret 10 is present and this apparatus is thus a single-beam system. It is recommended that an apparatus according to FIG. 1 be used for this single-beam installation. For the sake of simplicity, FIG. 2 shows only the lower part of this spunbond apparatus or the lower part of the diffuser 19 of this apparatus. In principle, the system or apparatus shown in FIG. 2 can also be used in the context of a multi-beam system. In order to preconsolidate with heat, and here, a hot-air knife 31 is first provided downstream of the deposition region 26 and a hot-air knife 32 is provided downstream of this hot-air knife 31 in the travel direction of the deposit mesh belt 20. Both hot-air preconsolidations take place on one and the same deposit mesh belt 20.

The hot-air preconsolidation with the hot-air knife 31 is preferably carried out and here is above the second suction region 29. The suction speed V₂ in this second suction region 29 is preferably and here 15% to 50%, in particular 25% to 40%, of the extraction speed V_{H} in the main suction region 27. As already explained above, the spoiler 30 ensures at the downstream suction separating wall 28.2 a gradual continuous transition of the high extraction speed V_{H} to the significantly lower extraction speed V₂ in the second suction region 29. Recommended masses and, here, process air is also sucked off under the hot-air oven 32 or this oven is operated in a circulation process, specifically with a suction or process air speed V₃. This suction or suction device air speed V₃ is expediently 5% to 30%, in particular 7% to 25% and for example 7% to 12% of the extraction speed V_{H} in the main suction region 27. Preferably, the suction speed of V_{H} in the main suction region 27 above V₂ in the second suction region 29 to V₃ decreases below the hot-air oven 32 (V_{H}>V₂>V₃). According to one embodiment of the invention, the extraction speed decreases continuously from the main suction region 27 via the second suction region 29 to the hot-air oven 32 by the deposit mesh belt 20. According to another embodiment, between the hot-air knife 31 and the hot-air oven 32, a non-evacuated region or only a small region of the deposit mesh belt 20 can be provided (so-called suction gap). In this case, the suction speed V_{L} in this suction gap region 34 is either zero or approximately zero or it is at least less than the suction speed V₂ below the hot-air knife 31 and preferably also less than the suction speed V₃ under the hot-air oven 32. Such a suction gap region 34 has proven successful for many applications. The invention is based on the discovery that, with the aid of this suction gap region 34, a relatively high desired thickness of a nonwoven web 2, 3 can be maintained without problems and nevertheless the required strength of the nonwoven web 2, 3 can be achieved with hot-air preconsolidation.

It has already been pointed out above that, according to a recommended embodiment of the invention, the suction gap region 34 is used to be able to position a further preconsolidator for the nonwoven web on the deposit conveyor or on the deposit mesh belt 20.

According to a preferred embodiment of the invention, a pair of rollers or pinch rollers serves for preconsolidation. This pair of rollers (not shown in the figures) can be pivoted on to the deposit conveyor or the deposit mesh belt 20 if necessary and can also be removed again or removed from contact with the deposit mesh belt 20 if necessary. In this respect, such a suction gap region 34 has proven particularly suitable between the hot-air knife 31 and the hot-air oven 32.

The hot-air preconsolidation of the nonwoven web 2, 3 with the hot-air knife 31 takes place preferably and, here, over a width range in the machine direction (MD) of 40 mm to 200 mm, in particular of 40 mm to 150 mm. The spacing of the at least one hot-air nozzle or the hot-air knife 31 to the surface of the mesh belt 20 is recommended here 2 mm to 200 mm and in particular 3 mm to 100 mm. The hot-air preconsolidation is preferably carried out with the hot-air knife 31 at a hot-air temperature of 80° C. to 250° C. and in particular at a hot-air temperature of 100° C. to 200° C. Preferably, the hot-air temperature is 120° C. to 190° C. Preferably the hot air in the hot-air preconsolidation with the hot-air knife 31 moves a speed of 2 to 5 m/s and preferably of 2.2 to 4.5 m/s. The spacing B of the hot-air knife 31 to the center plane M of the apparatus is in particular 100 mm to 1000 mm, preferably 110 mm to 600 mm and preferably 120 mm to 550 mm. The spacing B is measured in particular between this central plane M and the first component or component of the hot-air knife 31 downstream thereof in the travel direction.

Here, a hot-air oven 32 is provided downstream of the hot-air knife 31 preferably for the first hot-air preconsolidation. The spacing C between the hot-air knife 31 and the hot-air oven 32 is expediently. in the case of the apparatus of a suction gap region 34—0.4 m to 5.2 m, with the preferably provided hot-air oven 32 and the nonwoven web 2, 3 passing through a hot-air region with a dimension in the machine direction (MD) or in the travel direction of 280 mm to 2000 mm, preferably of 300 mm to 1500 mm. The hot-air outlet openings of the hot-air oven 32 have a spacing of 12 mm to 200 mm and preferably a spacing of 25 mm to 120 mm turned toward the surface of the deposit mesh belt 20. The nonwoven web 2, 3 is expediently preconsolidated in the hot-air oven 32 with hot air at a temperature of from 110° C. to 180° C., in particular from 115° C. to 170° C. and preferably from 120° C. to 160° C. The speed of the hot air in this hot-air preconsolidation in the hot-air oven 32 is 1 to 2.5 m/s, in particular 1.1 to 1.9 m/s and preferably 1.2 to 1.8 m/s. If work is carried out without a suction gap within the scope of the invention, the spacing between a hot-air knife and the downstream hot-air oven is expediently 0.3 m to 3.0 m

Moreover, it is within the scope of the invention that the hot-air preconsolidation with the upstream hot-air knife 31 takes place at a higher hot-air temperature than the hot-air preconsolidation with the downstream hot-air oven 32. Here according to FIG. 2, the nonwoven web is transferred to the downstream conveyor in the form of the conveyor belt 35 after preconsolidation with the hot-air oven 32 from the upstream deposit conveyor or from the deposit mesh belt 20. The conveyor belt 35 is expediently an endlessly circulating conveyor belt 35. According to a very preferred embodiment and here, the surface temperature of the conveyor belt 35 in the transfer region of the nonwoven web 2, 3 or in the region upstream of the hot-air final setting is higher than the surface temperature of the depositing conveyor or the mesh belt 20 in the region of transfer of the nonwoven web 2, 3 to the conveyor belt 35. The surface temperature of the conveyor belt 35 is expediently higher by at least 5° C., preferably by at least 10° C. and preferably by at least 15° C. than the stated surface temperature of the depositing conveyor or the mesh belt 20 in the region of transfer of the nonwoven web 2, 3. With the downstream conveyor or conveyor belt 35, the nonwoven web 2, 3 is fed to a final consolidation, specifically preferably and here of a hot-air final consolidation.

For this purpose, a hot-air final consolidator is provided for this purpose and, here, a hot-air final consolidator is provided, specifically recommended in the form of a hot-air final consolidator 36 (using air bonding). The nonwoven web 2, 3 is expediently subjected to a temperature of from 100° C. to 170° C. in particular from 110° C. to 150° C. in this final consolidator 36 with hot air. The finally consolidated nonwoven web or fabric 2, 3 can then be fed to its further use.

It is essential within the scope of the invention that the hot-air preconsolidation or preconsolidation of the nonwoven web 2, 3 is carried out on the depositing conveyor or on the mesh belt 20 such that the nonwoven web 2, 3 is fed to the downstream conveyor or to the downstream conveyor or to the storage mesh belt 20 upstream of the transfer from the deposit conveyor or the storage mesh belt 20 to the conveyor belt 35 with strength in the machine direction (MD) of 0.5 to 5 N/5 cm, in particular of 0.7 to 3.5 N/5 cm and preferably of 0.8 to 3.5 N/5 cm. This can be easily realized within the scope of the used or described hot-air preconsolidation.

FIG. 3 shows a preferred embodiment of an apparatus according to the invention in the form of a system with two beams or spinnerets 10. The structure of the apparatus component assigned to each beam or spinneret 10 preferably corresponds to the embodiment shown in FIG. 1 for construction of the spunbond apparatus shown in FIG. 1 above the mesh belt 20. For the sake of simplicity, in FIG. 3 these apparatuses are not shown completely, but only the lower region of the respective diffusers 19. With the first spunbond apparatus of the two-beam system according to FIG. 3, continuous filaments F are spun and deposited on the deposit mesh belt 20 to form a nonwoven web 2. Preferably and here, a second spunbond apparatus component (second beam, right-hand side of FIG. 3) likewise spins continuous filaments F and deposits the nonwoven web 3 on the first nonwoven web 2, so that a nonwoven laminate 2, 3 is formed from the two nonwoven webs 2 and 3. In principle, the two apparatuses shown in FIG. 3 can also be used in the context of a multibeam installation with more than two spinning beams or more than two spinnerets 10.

Preferably and here according to FIG. 3, each spunbond diffuser 19 is first followed by a hot-air knife 31 for hot-air preconsolidation. Each of the two hot-air knives 31 is preferred and, here for further flesh air preconsolidation, a respective hot-air consolidator 32 is provided downstream. The preferred parameters specified for the embodiment of FIG. 2 or parameter ranges with respect to the hot-air knife 31 and with respect to the hot-air knife 32 preferably also apply to the hot-air knives 31 and the hot-air ovens 32 of the two-beam system from FIG. 3. The same also applies to the values or the ratios/size ratios of the speeds V_{H}, V₂, V_{L} and V₃.

The two-beam apparatus of FIG. 3 differs in that the main suction regions 27 have different spoilers 30. In the upstream beam or spunbond apparatus on the left side, the spoiler 30 provided to the downstream suction wall 28.2 is angled to the side of the associated suction wall 28.2 that faces away from the center of the main suction region 27 or to the side of the associated suction wall 28.2 that faces away from the central plane M. As a result, a continuous and linear transition of the suction speeds from the extraction speed V_{H} of the main suction region 27 to the significantly lower extraction speed V₂ of the second suction region 29 is achieved. In the second beam or the second spunbond apparatus on the right-hand side of FIG. 3, the spoiler 30 is also provided to the downstream suction wall 28.2 of the main suction region 27. Here, however, the spoiler 30 is angled toward the center of the main suction region 27 or toward the central plane M. This configuration of the spoiler 30 achieves a continuously and linearly increasing suction speed from the relatively low extraction speed V_{V} of the upstream suction region 33 to the significantly higher suction speed V_{H} of the main suction region 27.

It is essential within the scope of the invention that, in accordance with a preferred embodiment and here, both nonwoven webs 2, 3 are deposited on the same deposit conveyor or on the same mesh belt 20 and are also subjected to hot-air preconsolidation on this deposit conveyor or storage mesh belt 20. Only subsequent thereto is the nonwoven laminate webs 2, 3 transferred from the deposit conveyor or storage mesh belt 20 to the downstream conveyor in the form of the conveyor belt 35 for final consolidation. The preferred features and parameters specified in connection with FIG. 2 to the hot-air final consolidating apparatus also apply to the hot-air final consolidator of FIG. 3. The same also applies to the temperatures or surface temperatures of the deposit conveyor or conveyor belt 20 and of the downstream conveyor or conveyor belt 35.

Preferably and here according to FIG. 3, the hot-air prebonding of the first nonwoven web 2 and the hot-air preconsolidation of the laminate from the two nonwoven webs 2, 3 takes place such that the laminate has a strength in the machine direction (MD) of 0.5 to 5 N/5 cm, in particular of 0.7 to 3.5 N/5 cm and preferably of 0.8 to 3.5 N/5 cm upstream of the transfer to the downstream conveyor or to the conveyor belt 35.

According to a very preferred embodiment, continuous filaments F in the form of bicomponent filaments or multicomponent filaments are made using the apparatus according to the invention and these continuous filaments F are deposited on the nonwoven web 2, 3 in the form of crimped filaments F. Crimp here means in particular that the crimped filaments each have a crimp with at least 1, 5, preferably with at least 2, preferably at least 2.5 and very preferably with at least 3 loops (loops) per centimeter of their length. According to a recommended embodiment, the crimped filaments each have a crimp of 2 to 3 loops per centimeter of their length. The number of crimping loops per centimeter of length of the filaments are measured in particular according to the Japanese standard JIS L-1015-1981 by counting the crimps under a bias of 2 mg/den in ( 1/10 mm) based on the unstretched lengths of the filaments. A sensitivity of 0.05 mm is used to determine the number of crimp loops. The measurement is expediently carried out using a “Favimat” apparatus from TexTechnno, Germany. For this purpose, reference is made to the publication “Automatic Crimp Measurement on Staple Fibers”, Denendorf Collocalium, “Textile Measuring and Testing Technology”, 9.11.99, Dr Ulrich Mortar (in particular page 4, FIG. 4). For this purpose, the filaments or the filament sample are removed from the deposit mesh belt as a filament bundle before further fixing and the filaments are separated and measured.

The crimp of the filaments is preferably achieved by the use of continuous filaments having an eccentric core-sheath configuration. Preferably, in the two-beam system of FIG. 3 with both spunbond apparatus components or with both beams, such bicomponent filaments are made with an eccentric core-sheath configuration.

FIG. 4 shows a bicomponent filament having an eccentric core-sheath configuration that is very particularly preferred within the scope of the invention. A cross section through an endless filament F with the preferred special core-sheath configuration is shown in FIG. 4. In these continuous filaments F, the sheath 37 preferably has a constant thickness d in cross-section over more than 50%, preferably over more than 55% of the filament circumference. Preferably and here, the core 4 of the filaments F occupies more than 65% of the area of the filament cross-section of the filament F. Recommended and here, the core 4, as seen in the cross-section of the filament, is segmental. Expediently and here, this core 4 has a circularly arcuate circumferential section 5 and a planar circumferential section 6 with respect to its circumference. Preferably and here, the circularly arcuate circumferential section of the core 4 takes over 50%, preferably over 55%, of the circumference of the core 4. Expediently and here, the sheath 37 of the filaments F, as seen in the filament cross-section, is designed to be circular segment-shaped outside the sheath region with the constant thickness d. This circular segment 7 of the casing 37 is recommended and has, here, a circular arc-shaped circumference section 8 and a linear circumferential section 9 with respect to its circumference. Preferably, the thickness d or the average thickness d of the sheath 37 in the region of its constant thickness is 0.5% to 8%, in particular 2% to 10% of the filament diameter D. Here, the thickness d of the sheath 37 in the region of its constant thickness may be 0.05 μm to 3 μm.

1. An apparatus for making a nonwoven fabric having a nonwoven web, the apparatus comprising
a spinneret or spinning beam for spinning fibers,
an upstream mesh belt on which the fibers are deposited by the spinneret or beam to form a first nonwoven web,
an upstream hot-air preconsolidator for hot-air preconsolidation of the nonwoven web on the upstream mesh belt,
a downstream belt downstream of upstream mesh belt in the travel direction of the nonwoven web, for receiving the preconsolidated nonwoven web from the upstream mesh belt,
a hot-air final consolidator, for the final consolidation of the nonwoven web on the downstream belt, the hot-air preconsolidation of the nonwoven web on the upstream mesh belt being carried out such that the nonwoven web has a strength in the machine direction of 0.5 to 5 N/5 cm upstream of the downstream belt, the temperature of the surface of the downstream belt in the travel direction upstream of the hot-air final consolidator being higher than the temperature of the surface of the upstream mesh belt in the transfer region of the nonwoven web or laminate to the downstream conveyor.

2. The apparatus according to claim 1, wherein
the nonwoven fabric is a nonwoven laminate of first and second nonwoven webs,
upstream and downstream spinnerets or spinning beams are provided,
the upstream spinneret or spinning beam is provided for spinning first fibers and depositing the first fibers on the upstream mesh belt to form the first nonwoven web,
the downstream spinneret or spinning beam is provided for spinning second fibers and depositing the second spinning beam as the second nonwoven web downstream of the upstream spinning beam in the travel direction on the first nonwoven web,
the upstream hot-air preconsolidator is provided between the upstream and the downstream spinning beam for hot-air preconsolidation of the first nonwoven web,
a second hot-air preconsolidator for hot-air prebonding of the second nonwoven web or a laminate of the first and second nonwoven webs is downstream of the second spinning beam in the travel direction,
the laminate is transferred from the deposit conveyor to the downstream belt,
the laminate is finished with the final hot-air final consolidator on the downstream conveyor, and
the hot-air preconsolidation of the nonwoven web or laminate on the deposit conveyor can be carried out such that the laminate has a strength in the machine direction of 0.5 to 5 N/5 cm before transfer to the downstream conveyor.

3. The apparatus according to claim 1, wherein the spinneret or spinning beam is an apparatus for making spunbond nonwoven materials from continuous filaments.

4. The apparatus according to claim 1, wherein the spinneret or the spinning beam is configured to produce bicomponent fibers or multicomponent fibers.

5. The apparatus according to claim 1, wherein the spinneret or beam makes crimped fibers or crimped continuous filaments.

6. The apparatus according to claim 1, further comprising:
a cooler for cooling the fibers and
a stretcher downstream in a filament-travel direction from the cooler for elongating the fibers and a diffuser adjoining the stretcher, for the fibers spun by the spinneret or the a spinning beam.

7. The apparatus according to claim 6, wherein subassembly formed by the cooler and stretcher is a closed unit that no further air can enter from the outside except for the cooling air in the cooler.

8. The apparatus according to claim 1, wherein the hot-air preconsolidator is a hot-air knife and/or a hot-air oven.

9. The apparatus according to claim 1, wherein the upstream hot-air preconsolidator is between the upstream spinning beam and the downstream spinning beam and is a first hot-air knife and/or a first hot-air oven.

10. The apparatus according to claim 9, wherein the first hot-air knife is provided downstream of the upstream spinning beam in the travel direction of the first nonwoven web, and a first hot-air oven is provided downstream of this first hot-air knife upstream of the second spinning beam.

11. The apparatus according to claim 2, wherein the downstream hot-air preconsolidator downstream of the downstream spinning beam is a second hot-air knife and/or a second hot-air oven.

12. The apparatus according to claim 11, wherein the second hot-air knife is provided downstream of the downstream spinning beam in the travel direction of the laminate, and a second hot-air oven is provided downstream of the second hot-air knife.

13. The apparatus according to claim 8, wherein the hot-air knife subjects the nonwoven web or the laminate to hot air over a width region in the machine direction of 15 mm to 300 mm and/or a spacing of the hot-air nozzle of the second hot-air knife to the surface of the conveyor or to the surface of the mesh belt is 2 mm to 200 mm.

14. The apparatus according to claim 8, wherein the hot-air oven applies hot air to the nonwoven web or laminate over a width range in the machine direction of 280 mm to 2000 mm and/or hot-air outlet openings of the hot-air oven have a spacing of 12 mm to 200 mm to the surface of the deposit conveyor or to the surface of the deposit mesh belt.

15. A method of making a nonwoven fabric having a nonwoven web by the steps of:
spinning fibers and depositing them on an upstream mesh belt to form the nonwoven web,
preconsolidating the nonwoven web with hot air on the upstream mesh belt such that the nonwoven web has a strength in the machine direction of 0.5 to 5 N/5 cm,
transferring the preconsolidated nonwoven web from the upstream mesh belt to a downstream mesh belt,
finally consolidating the nonwoven on the upstream downstream mesh belt, and
maintaining a temperature of the surface of the downstream belt in the travel direction upstream of the hot-air final consolidator higher than the temperature of the surface of the mesh belt in the transfer region of the nonwoven web or laminate to the downstream conveyor.

16. The method according to claim 15, wherein
a nonwoven laminate is made from at least two of the nonwoven webs,
at least one of the nonwoven webs comprises crimped fibers,
first fibers are spun and deposited on a mesh belt to form a first nonwoven web,
second fibers are spun into a second nonwoven web and then deposited on the first nonwoven web to form the laminate from the two nonwoven webs,
after depositing the first fibers and before depositing the second fibers, the first nonwoven web is preconsolidated with hot air, and, after depositing the second fibers, the second nonwoven web or laminate is preconsolidated with hot air,
the laminate is transferred from the deposit conveyor or the deposit mesh belt to the downstream conveyor or to the conveyor belt, and the hot-air preconsolidation is carried out such that the laminate has a strength in the machine direction of 0.5 to 5 N/5 cm before or during transfer to the downstream conveyor.

17. The method according to claim 15, wherein the fibers are spunbond or continuous bicomponent filaments or multicomponent filaments and are preferably deposited as crimped filaments as the first nonwoven web and/or as the second nonwoven web.

18. The method according to claim 15, wherein the fibers are spun as bicomponent filaments or multicomponent filaments having an eccentric core-sheath configuration.

19. The method according to claim 15, wherein the nonwoven web, in particular the first nonwoven web and/or the laminate from the first nonwoven web and the second nonwoven web are preconsolidated by a hot-air knife with hot air at a hot-air temperature of 80° C. to 250° C. and/or wherein the hot air has a speed of 1.9 to 8 m/s during the hot-air preconsolidation.

20. The method according to claim 15, wherein the first nonwoven web and/or the laminate of the first nonwoven web and the second nonwoven web is preconsolidated by a hot-air oven with hot air at a temperature of 110° C. to 180° C. and/or wherein the hot air has a speed of 1 to 2.5 m/s during this hot-air consolidation.

21. The method according to claim 15, wherein the surface temperature of the downstream conveyor in the region upstream of the hot-air final consolidation or in the region of transfer of the nonwoven web or the laminate is higher than the surface temperature of the conveyor or the mesh belt in the region of transfer of the nonwoven web or the laminate to the downstream conveyor and this surface temperature of the downstream conveyor is higher by at least 5° C. than this surface temperature of the deposit conveyor in the region of transfer of the nonwoven web or the laminate to the downstream conveyor.
